(19) United States
(12) Patent Application Publication
(10) Pub. No.: US 2010/0072716 A1
(43) Pub. Date: Mar. 25, 2010

(54) Portable tool storage assembly

(76) Inventor: Larry Mitchell Grela, Plainfield, IL (US)

Correspondence Address: John G. Chupa;Law Offices of John Chupa and Associates, P.C., 28535 Orchard Lake Rd., Suite 50, Farmington Hills, MI, 48334, US

(21) Appl. No.: 12/284,200

(22) Filed: Sep. 19, 2008

(51) Int. Cl. B62B 3/02

(52) U.S. Cl. 280/47.35

(57) ABSTRACT

A tool assembly 10 having a plurality of wheels 22, 24, 26, and which allow the assembly 10 to be easily transported from place to place, and a second portion 80 which may be easily removed from a first and fixed operative position to any desired location.

### FIELD OF THE INVENTION

The present invention generally relates to a portable tool storage assembly and more particularly to a portable tool storage assembly which includes a first portion which may be easily and selectively transported from place to place and a top container portion which is selectively and removably attached to the first portion by a number of pillar or columnar members.

### BACKGROUND OF THE INVENTION

Containers are used to selectively store tools and other items which are used in a wide variety of applications, such as by way of example and without limitation, automobile and truck repair applications and construction applications. Such containers are often referred to as “tool boxes” but such an acronym really masks the fact that such containers are used to store a wide variety of other items (e.g., medical items).

While current tool containers do allow tools and other items to be selectively stored, they are relatively heavy and are difficult to transport from one place to another (e.g., requiring that they be actually and physically lifted by a user), thereby increasing the amount of time and difficulty associated with performing a certain activity or application and increasing the likelihood of injury to the user. In order to overcome this drawback, some portable containers have been created and which include wheels which are effective to allow them to be pushed around a given locale. While these containers do provide some enhanced utility over the previously described containers, they require the movement of the entire and oftentimes large container and are not amenable to being taken to a job site or other location due to the fact that they are large and heavy and remain coupled to wheels which may be easily broken or damaged on the job site.

There is therefore a need for a new and improved tool storage assembly which is easily transported from place to place and which concomitantly allows for the removal and use of a certain portion of the assembly (e.g., by manual transportation). The present invention provides such a new and improved tool storage assembly.

### SUMMARY OF THE INVENTION

It is a first non-limiting object of the invention to provide a new and improved tool storage assembly which overcomes some or all of the drawbacks associated with prior and current tool storage assemblies, such as by way of example and without limitation, those delineated above.

It is a second non-limiting object of the invention to provide a new and improved tool storage assembly which includes a first and easily movable portion and a second storage portion which may be easily and selectively secured to and removed from the first portion.

According to a first non-limiting aspect of the present invention, a portable tool storage assembly is provided and includes a bottom portion including a generally flat base; a plurality of wheels which are attached to and which are operatively disposed upon the generally flat base; a plurality of pillars which are attached to the generally flat base and which extend from the generally flat base in a direction opposite to the plurality of wheels; a drawer assembly which is disposed upon the plurality of pillars and which overlays the generally flat base, wherein the drawer assembly includes a plurality of drawers; and a top portion which is removably attached to the drawer assembly and which provides at least one storage cavity.

These and other features, aspects, and advantages of the present invention will become apparent from a reading of the following drawings and the detailed description of the preferred embodiment of the invention, including the subjoined claims.

### BRIEF DESCRIPTION OF THE DRAWINGS

FIG. 1 is a perspective view of a tool container assembly which is made in accordance with the teachings of the preferred embodiment of the invention.

### DETAILED DESCRIPTION OF THE PREFERRED EMBODIMENT OF THE INVENTION

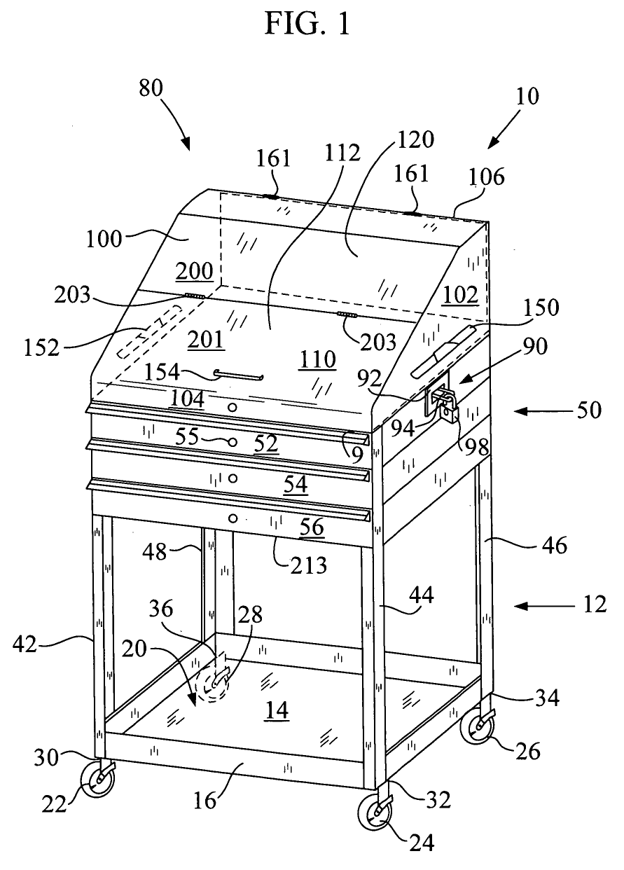

Referring now to FIG. 1, there is shown a portable tool storage assembly 10 which is made in accordance with the teachings of the preferred embodiment of the invention.

Particularly, the portable tool storage assembly 10 includes a first base portion 12 having a generally flat bottom member 14 which is substantially surrounded, at its periphery, by a wall member or portion 16 which cooperates with the member 14 to allow the base portion to form a storage cavity 20 and the cavity 20 has a height equal to the height of member 16. Items of substantially any desired type may be selectively placed within and selectively removed from the storage cavity 20. The portable tool storage assembly 10 further includes a plurality of substantially identical wheels 22, 24, 26, and 28 which are respectively and operatively coupled to unique corners 30,32, 34, and 36 of the member 14 and which cooperative allow the entire portable tool storage assembly 10 to be easily and selectively transported from place to place.

As is further shown in FIG. 1, the portable tool storage assembly 10 includes a plurality of substantially identical pillars or column type members 42, 44, 46, and 48 which are respectively coupled to corners 30, 32, 34, and 36 of the base member 14 and which emanate and protrude from the base member 14 in a direction away from the wheels 22, 24, 26, and 28. The members 42-48 may, for example and without limitation, be welded to the base member 14 or they may be integrally formed with the base member 14. It should be realized that the size and shape of member 14 and members 42-48 may be varied as desired.

Further, the assembly 10 includes a drawer assembly 50 which is coupled to the pillars or columns 42, 44, 46, and 48 (e.g., such as by welded type members) and these members 42-48 cooperatively and operatively position the drawer assembly above the member 14. The drawer assembly 50 includes several substantially identical drawers 52, 54, and 56 and each of these drawers 52, 54, 56 includes a knob or handle 55 and provides a unique and respective storage cavity into which tools or other items may be selectively placed; Each of the drawers 52, 54, and 56 may be selectively opened (e.g., pulled away from the assembly 10) and closed (as shown in FIG. 1) to allow access to the respective cavities.

On top of the drawer assembly 50 is operatively positioned a storage assembly 80 which sits upon the top drawer 52 and is selectively and removably coupled to the top drawer 52 by at least one latch assembly 90. That is, latch assembly 90 includes a first rectangular portion 92 which is coupled to the assembly 80 and a second protruding portion 94 which is coupled to the drawer 52 and which protrudes from the drawer 52. The portion 94 is selectively received by the portion 92 and traverses portion 92 and may selectively receive a lock 98, thereby selectively securing the portion 94 within the portion 92 and selectively but removably fixing the assembly 80 upon the drawer assembly 50. Other fastening techniques and strategies may be employed to selectively and removably couple the assembly 80 to the drawer assembly 50.

The assembly 80 includes substantially identical side members 100, 102 and a front member 104 which is coupled to the members 100, 102, such as by the use of a welded type connection or some other type of connection. The assembly 80 also includes a back member 106 which is coupled to the side members 100, 102, and a bottom member 110 which is coupled to the members 100, 102, 106, and 104. Such foregoing coupling may also be accomplished by the use of a welded type connection or any other type of fastening type connections. Bottom member selectively and removably abuts to top surface 9 of drawer 52. These members 104, 100, 102, 106, and 110 cooperatively define at least one internal storage cavity 112 and tools and/or other desired types of items may be selectively and removably placed within the internal storage cavity 112. The assembly 80 further includes a top member 120 which is pivotally coupled to the back member 106 (e.g., by at least two hinge members 161) and removably abuts the members 100, 102 and 104. In another non-limiting embodiment, the member 120 integrally terminates into the member 106 and is flexible. In this manner, the member 120 is selectively movable from a first closed position (shown explicitly in FIG. 1) to an open position (i.e., the member 120 moves away from the wheels 22-28 and toward the member 106), thereby exposing the internal cavity 112. In this manner tools and other items may be selectively placed within and taken out of the internal cavity 112. In yet another non-limiting embodiment, the member 120 is formed from two members 20b, 201 and members 200, 201 are hingedly coupled, such as by the use of hinges 203, and member 200 is hingedly connected to member 106.

Further, substantially identical handles 150, 152 are respectively deployed upon the side members 100, 102 and handle 154 may be deployed upon the member 120. In this manner, the assembly 80 may be selectively removed from its selectively fixed position upon the drawer assembly 50 and taken to a job site or elsewhere. Thus, the assembly 10 provides an assembly that may be, in total, “wheeled” to a place, and a pre-selected portion of the assembly 10 (namely portion 80) may be selectively removed from assembly 10 and manually or otherwise transported to another area or site. In yet another non-limiting embodiment, the entire assembly 10 is formed form stainless steel and in yet a further non-limiting embodiment of the invention, a door member is coupled to unique member 42, 44; to member 44, 46; to member 46,48; and to members 42,48. In this manner, the storage cavity 20 is extended from bottom member 14 to the bottom 213 of drawer 56. It should also be understood that the top member 80 really comprises a storage hutch and may take substantially any desired shape. Further, pneumatic or some other sort of lift assist member(s) may be deployed within the assembly 80 to allow the top member 120 to be easily and selectively opened.

It is to be understood that the inventions are not limited to the exact construction or methodology which has been delineated above, but that various changes and modifications may be made without departing from the spirit and the scope of the inventions as are set forth more fully in the following claims. It should further be appreciated that tools and/or other desired items may be selectively placed within the assembly 10.

What is claimed is:

1) A portable tool storage assembly comprising a storage portion; and a plurality of wheels which are coupled to said storage portion which are cooperatively effective to allow said storage portion to be selectively moved, wherein said storage portion includes another portion which may be manually removed from said storage portion.

2) A portable tool storage assembly comprising a bottom portion including a generally flat base; a plurality of wheels which are attached to and which are operatively disposed upon said generally flat base; a plurality of pillars which are attached to said generally flat base and which extend from said generally flat base in a direction opposite said plurality of wheels; a drawer assembly which is disposed upon said plurality of pillars and which overlays said generally flat base, wherein said drawer assembly includes a plurality of drawers; and a top portion which is selectively and removably attached to said drawer assembly and which provides at least one storage cavity.

3) The portable tool storage assembly of claim 2 wherein top portion includes a flat base having four opposed sides; four walls which are each respectively coupled to a unique one of said four opposed sides, wherein only two of said four opposed walls have a substantially identical height; and a top which is coupled to one of said four opposed walls and which selectively and removably abuts all but said one of said four opposed walls.

4) The portable tool storage assembly of claim 3 wherein said top is hingedly coupled to said one of said four opposed walls.

5) The portable tool storage assembly of claim 4 further comprising a handle member upon each of said two of said four opposed walls.

6) The portable tool storage assembly of claim 5 further comprising a plurality of door members and wherein each of said door members is attached to a unique pair of said pillars.

7) The portable tool storage assembly of claim 6 wherein said portable tool storage assembly is manufactured form stainless steel.

8) The portable tool storage assembly of claim 7 wherein said top portion comprises a hutch.
